(19) United States
(12) Patent Application Publication
(10) Pub. No.: US 2016/0321924 A1
(43) Pub. Date: Nov. 3, 2016

(54) PREDICTIVE ROAD HAZARD IDENTIFICATION SYSTEM

(71) Applicants: Hyundai America Technical Center, Inc., Superior Township, MI (US); Hyundai Motor Company, Seoul (KR); Kia Motors Corporation, Seoul (KR)

(72) Inventors: Allan Lewis, Windsor (CA); Mohammad Naserian, Windsor (CA)

(73) Assignees: Hyundai America Technical Center, Inc., Superior Township, MI (US); Hyundai Motor Company, Seoul (KR); Kia Motors Corporation, Seoul (KR)

(21) Appl. No.: 14/701,716

(22) Filed: May 1, 2015

(51) Int. Cl. G08G 1/0967

(52) U.S. Cl. CPC G08G 1/096791

(57) ABSTRACT

A system and method are provided for identifying a potential road hazard in a host vehicle based on a remote vehicle. The host vehicle has a host vehicle-to-vehicle (V2V) module and a host advanced driver assistant system (ADAS) module, such as a system employing the ADASIS standard. The remote vehicle also has a remote V2V module that provides position data, and one or more of, longitudinal acceleration data, steering angle change rate data, braking system data, anti-lock braking status and stability control system status of the remote vehicle. The host vehicle receives the position data of the remote vehicle using the host V2V module and determines if the remote vehicle is in the main path zone (MPZ) of the host vehicle. The system determines a potential road hazard when it receives a signal indicating any of the following are true, the longitudinal acceleration data and/or the steering angle change rate data of the remote vehicle exceeds a predetermined threshold, the anti-lock braking system of the remote vehicle is activated, or the stability control system of the remote vehicle is activated. The system indicates the potential road hazard to a driver of the host vehicle when a potential road hazard is identified and the remote vehicle is in the MPZ of the host vehicle.

### FIELD

The present invention relates to alerting a driver of a potential road hazard ahead of a vehicle path, and more particularly to utilizing a vehicle-to-vehicle (V2V) network for identification of road hazards.

### BACKGROUND

The statements in this section merely provide background information related to the present disclosure and may not constitute prior art.

Efforts have been underway for some time to establish standards for and to develop technology that would allow drivers within limited geographic areas to “talk” to each other by participating in ad hoc vehicle-to-vehicle (V2V) networks in which data is shared among participating vehicles. Various suitable V2V systems and protocols are disclosed in U.S. Pat. Nos. 6,925,378, 6,985,089, and 7,418,346, each of which is incorporated by reference in its entirety.

According to one proposal, data would be shared among vehicles using a Dedicated Short Range Communications (DSRC) wireless protocol operating in the 5.9 Gigahertz band that would support direct V2V communications over a relatively short range, approximately 800 m. The effective size of the network implemented using the DSRC would be significantly greater than the direct vehicle-to-vehicle maximum range, however, since each vehicle could relay data received from another vehicle to still other vehicles within its range. Relayed data could “hop” one vehicle at the time to vehicles progressively further away from the vehicle that was the source of the data.

Vehicle navigation systems using global positioning systems (“GPS”) are also known, and more recently include advanced driver assistance systems (“ADAS”). An industry standard is available, and still actively being developed, for the transmission of data between the navigation system and other components in the vehicle, namely advanced driver assistant systems interface specification (“ADASIS”). ADAS applications include an electronic map of the area surrounding a vehicle, and may be derived from a full electronic map of the type used for vehicle navigation devices, but generally contain a subset of the navigation information. For example, an ADAS application typically obtains information on speed limits, road curvature and lane information, but may omit information such as street names.

### SUMMARY

The invention may include any of the following aspects in various combinations and may also include any other aspect described below in the written description or in the attached drawings.

According to one aspect, a method is provided for identifying a potential road hazard in a host vehicle based on a remote vehicle. The host vehicle has a host vehicle-to-vehicle (“V2V”) module and a host advanced driver assistant system (“ADAS”) module, such as a system employing the ADASIS standard. The remote vehicle also has a remote V2V module that provides position data, and one or more of, longitudinal acceleration data, steering angle change rate data, braking system data, anti-lock braking status and stability control system status of the remote vehicle. The method preferably comprises the steps of computing a main path zone (MPZ) of the host vehicle using the host ADAS module. The host vehicle receives the position data of the remote vehicle using the host V2V module and determines if the remote vehicle is in the MPZ of the host vehicle. The system determines a potential road hazard when it receives a signal indicating any of the following are true, the longitudinal acceleration data and/or the steering angle change rate data of the remote vehicle exceeds a predetermined threshold, the anti-lock braking system of the remote vehicle is activated, or the stability control system of the remote vehicle is activated. The system indicates the potential road hazard to a driver of the host vehicle when a potential road hazard is identified and the remote vehicle is in the MPZ of the host vehicle.

According to a second aspect, a road hazard identification system is provided for a host vehicle. The road hazard identification system has a host V2V module and a host ADAS module. The host ADAS module computes a main path zone (MPZ) of the host vehicle. The host vehicle communicates with a remote vehicle having a remote V2V module. The host V2V module receives position data and at least one of longitudinal acceleration data and steering angle change rate data from the remote V2V module. The system comprises of a processor configured to determine if the remote vehicle is in the MPZ of the host vehicle. The system determines a potential road hazard when the at least one of longitudinal acceleration data and steering angle change rate data of the remote vehicle exceed a predetermined threshold. The system indicates the potential road hazard to a driver of the host vehicle when remote vehicle is in the MPZ of the host vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a predictive road hazard identification system;

FIG. 2 is an ADAS path view;

FIG. 3 is an application view of the ADAS path view of FIG. 2;

FIG. 4 is a perspective view of one embodiment of the present invention;

FIG. 5 is a flow chart for one embodiment of the present invention;

FIG. 6A is a flow chart for one embodiment of an evasive maneuver of the present invention;

FIG. 6B is a flow chart for a second embodiment of the evasive maneuver of the present invention;

FIG. 6C is a flow chart for third embodiment of the evasive maneuver of the present invention;

FIG. 7 is a flow chart for a dynamic event of the present invention; and

FIG. 8A is a perspective view of one example of the present invention on a multiple lane road;

FIG. 8B is another perspective view of another example of the present invention on the multiple lane road;

The drawings described herein are for illustration purposes only and are not intended to limit the scope of the present disclosure in any way.

### DETAILED DESCRIPTION

The present disclosure will now be described more fully with reference to the accompanying figures, which show preferred embodiments. The accompanying figures are provided for general understanding of the structure of various embodiments. However, this disclosure may be embodied in many different forms. These figures should not be construed as limiting.

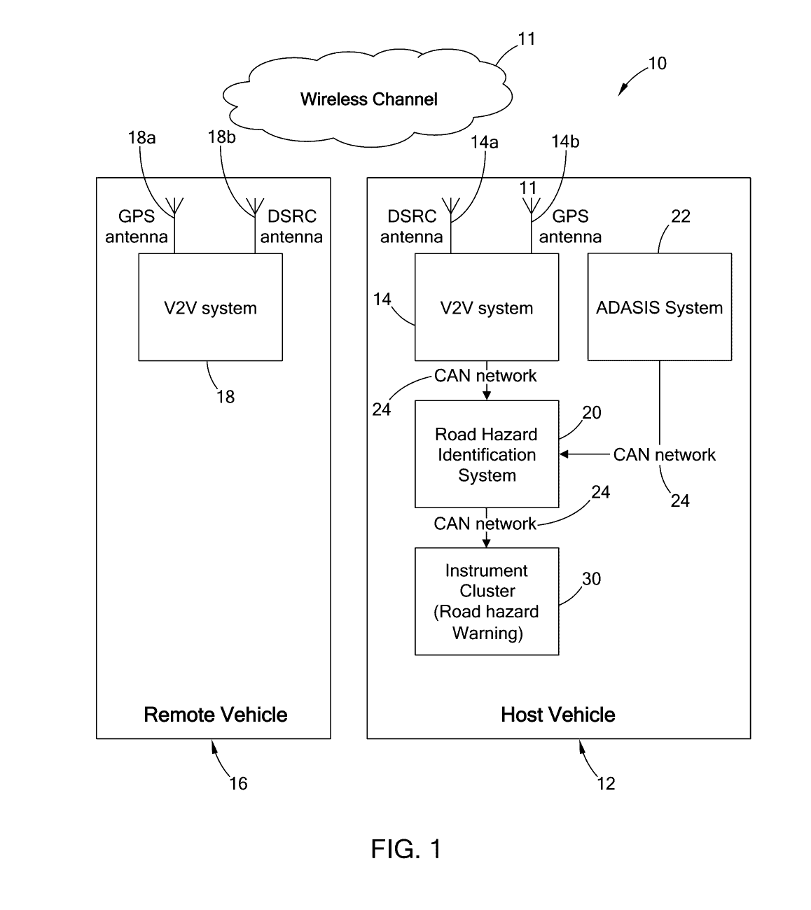

FIG. 1 illustrates a multiple vehicle system 10 having a host vehicle 12 that receives data over a wireless channel 11 via a host V2V module 14, which in turn can be used to alert a driver of the host vehicle of a nearby or potential road hazard. The system 10 utilizes a remote vehicle 16 in the area that transmits data by a remote V2V module 18, e.g., data based on The Society of Automotive Engineering standard SAE J2735. The V2V modules 14, 18 preferably each include a Dedicated Short Range Communication (DSRC) antenna 14a, 18a for transmitting the data and creation of an ad-hoc network to communicate with nearby vehicles. Each vehicle also preferably includes a global position antenna 14b, 18b for receiving the global positioning system (“GPS”) coordinates identifying the location of the respective vehicles. It will be recognized by those skilled in the art that other antennae and communication protocols for determining vehicle position and communicating between vehicles may also be employed.

The data transmit by the DSRC antenna 14a, 18a may include various data from the remote vehicle related to the Basic Safety Message (“BSM”), which is part of the SAE J2735 standard. The table below indicates some of the common data transmitted as part of BSM. The V2V modules 14, 18 allow for a remote vehicle 16 that is traveling down a roadway to transmit BSM data to allow for advanced notification to following vehicles within the vicinity. The BSM data may include in part one the following vehicle information and any additional data set forth in SAE Standard J2735.

While the SAE standard J 2735 currently defines BSM data, it is still under development. As V2V communications are implemented additional changes to the standard and BSM data may be required. However, currently the BSM data includes information related to the message including a sequence number, a vehicle temp ID, and a time stamp. The BSM data further includes positional data from a Global Positioning System (GPS) which includes latitude, longitude, elevation and accuracy of the position. The BSM data may also include vehicle information such as speed and transmission state, heading, and physical information such as a vehicle length, width and weight. The BSM data may also include information about vehicles controls such as steering angle, acceleration, yaw rate, brake status, and additional information from control systems such as ABS and stability control. It is also appreciated that SAE standards, or newer alternate standards may change and BSM data protocol may be expanded to include various other information about the vehicle, history logs and positioning or heading information.

Additionally, in the present disclosure the vehicles 12, 16 may optionally transmit and store additional BSM data. The additional BSM data may be stored and transmitted by the V2V modules 14, 18 in either the host or remote vehicle. The BSM data may provide a log history and transmit event flags, a path history, path prediction and relative positioning based on standards from the Radio Technical Commission and Maritime Services (RTCM). It is appreciated that the V2V module may also communicate to other networks for signaling issues to road maintenance or networks that store and transmit BSM data to vehicles not in the vicinity at the time of the event.

In one form the system 10 includes a road hazard identification system 20 installed in the host vehicle (HV) 12. The road hazard identification system 20 is a processor, circuit, computer or the like (or software with instructions for an existing processor, circuit or computer in the host vehicle 12) that communicates with the host V2V module 14. The road hazard identification system 20 obtains and evaluates the BSM data transmitted by remote vehicle (RV) 16 in the vicinity, preferably using the existing Controlled Area Network (CAN) network 24 of the host vehicle 12.

The road hazard identification system 20 uniquely integrates data from a navigation system, such as an ADAS module 22 employing the ADASIS protocol (discussed further below), to provide for the identification of potential road hazards. The identification system 20 also preferably communicates with the ADAS module 22 via the CAN network 24. In this way, the identification system 20 can discard non-relevant BSM and avoid false notifications or indications to the driver.

The host vehicle 12 further includes an instrument cluster 30 connected to the CAN network 24. The identification system 20 communicates with the instrument cluster 30 to warn the driver of the potential hazard. Other types of indicators may also be used, such as those in the navigation system, radio, heads-up displays, center stack, console or other locations visible to the driver. It is appreciated that the instrument cluster may include various visual displays, audio or tactile feedback to warn the driver.

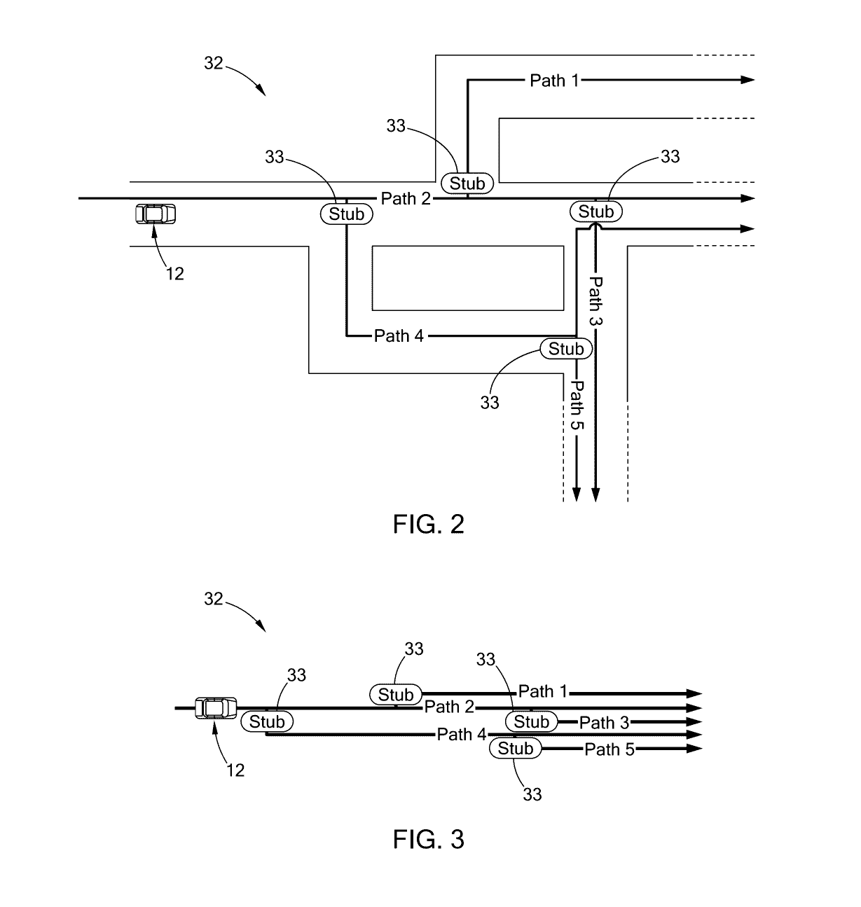

As briefly discussed above, the Advanced Driver Assistance System Interface Specifications, commonly referred to as ADASIS, is an international standard for mapping data that is provided by the ADAS module 22 that defines the road geometry ahead of the host vehicle 12 based on the map data and GPS coordinates of the vehicle. ADASIS standard data is defined by European Road Transport Telematics Implementation Co-ordination Organisation, ERTICO, under their Intelligent Transportation System (ITS), although other navigation systems and advanced driver assistance systems may be employed. ADASIS provides a standardized interface to predict the road geometry with related attributes ahead of the vehicle based on the vehicles Global Positioning System (GPS) data and the digital ADASIS road map, as will be discussed in further detail below with reference to FIGS. 2-5.

The ADAS module 22 in the host vehicle 12 may include road geometry and road attributes stored on-board within the ADAS module 22. The ADAS module 22 may further include a data connection (not shown) in communication with the CAN network 24 that allows the ADAS module 22 to update the road geometry from a remote data source, i.e., a cellular connection or similar data connection used in the art. The ADAS road data includes various operating and environment conditions for a path such as road slope, curvature, speed limit, and stop sign placement. The ADAS road data may also provide definitions of the most probable path as well as all possible route options and can define paths up to 8 km ahead of the host vehicle 12.

Referring to FIGS. 2 and 3, the ADAS module 22 provides the road hazard identification system 20 with a roadmap 32 of all possible paths a host vehicle 12 can travel. The identification system 20 calculates and predicts a main path zone that defines a most probable path for the host vehicle from all paths within the roadmap 32 of the ADAS road data (“MPZ”). The ADAS module 22 also identifies stub path locations 33, which typically indicate the start of an optional path that the host vehicle may travel, such as at an intersection of roads. The road hazard identification system 20 determines the MPZ by a probability calculation, and may consider such variables as the distance to the destination, the shortest route, fastest arrival time, least number of turns or traffic stops, and the system may further consider real-time variables such as traffic, an accident or a remote vehicle BSM to determine the most probable MPZ. Once the MPZ is determined, the identification system 20 uses the MPZ and calculates by mathematical methods along with the ADAS road data to determine the GPS coordinates, distance and curvature of the roadway of the MPZ. As discussed further below, the identification system 20 uses the MPZ to determine if the remote vehicle transmitting the BSM data is within the MPZ of the host vehicle, as well as evaluates the road geometry and stub locations to avoid false road hazard notifications to the driver, and discards BSM data not relevant to the MPZ.

For example, in FIG. 2 a road map 32 is depicted, and the most probable path MPZ for the host vehicle 12 would be Path 2, since in this example is a straight path with the least number of turns, although this can differ based on vehicle speed, accidents or programmed destination data. The application view in FIG. 3 further indicates another view of the roadmap 32 of FIG. 2 along with the stub locations. This information allows the identification system 20 to calculate the MPZ for the host vehicle and discard or filter out BSM data from remote vehicles outside of the MPZ.

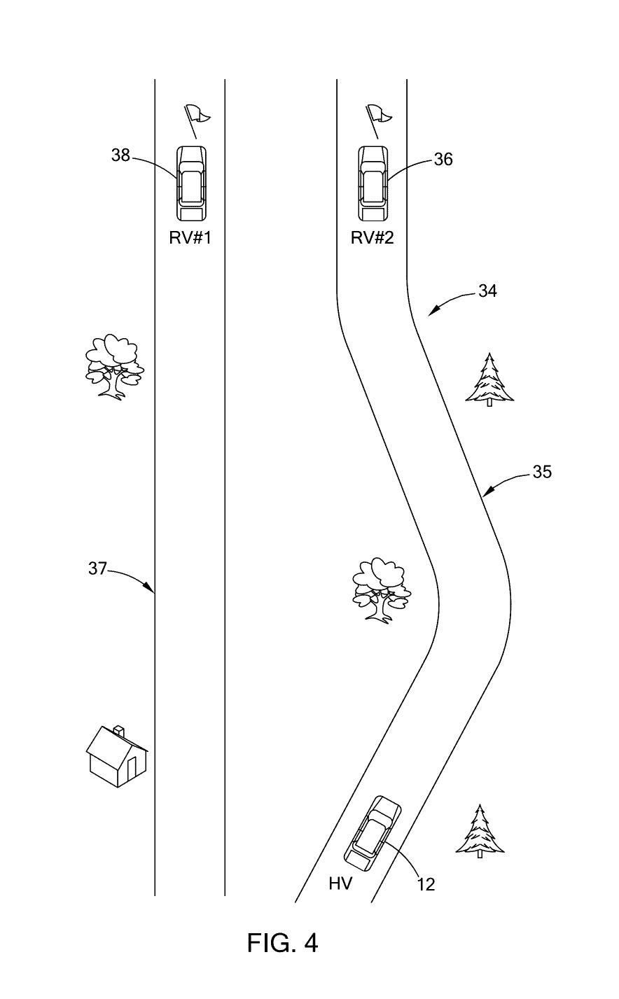

As another example, and with reference to FIG. 4, the Host Vehicle (HV) 12 is traveling the depicted curved roadway 35, and the MPZ 34 for the host vehicle 12 is indicated by the shading. A second remote vehicle (RV #2) 36 is ahead of the host vehicle 12 and BSM data transmitted by the second remote vehicle 26 may be able to provide an early warning of roadway conditions and potential road hazards on the MPZ 34 since the MPZ 34 of the host vehicle 12 will soon be traveling the same road or path as the second remote vehicle 36. However, the first remote vehicle (RV #1) 38 is on a different nearby roadway 37 and BSM data received from remote vehicle #1 38 is of limited use to the driver of the host vehicle 12. By way of the present disclosure, the road hazard identification system 20, using data from the ADAS module 22 and the stored road geometry, is able to accurately identify road hazard alerts to the driver of conditions affecting the MPZ 34 of the host vehicle 12. In this example, the identification system 20 would ignore or discard any BSM data from the first remote vehicle 38 and only evaluate the BSM data from the second remote vehicle 34. If the identification system determines that a remote vehicle executes an evasive maneuver or experiences a dynamic event, the driver of the host vehicle 12 can be warned, as will be discussed in further detail below,

It will be recognized that the identification system 20 may also be programmed to determine a relational path or probable trajectory of any remote vehicle in range of the wireless channel 11, and utilize the BSM data if the relational or projected path crosses through or toward the MPZ of the host vehicle. In such instances the identification system 20 may provide a warning to indicate an erratic driving behavior or warning that a remote vehicle has left their lane or roadway and indicate the relational path. The identification system 20, by calculating the MPZ using the ADAS module 22, is able to further filter out false alarms by knowing the location of the remote vehicles in the vicinity and the relation to the MPZ of the host vehicle 12.

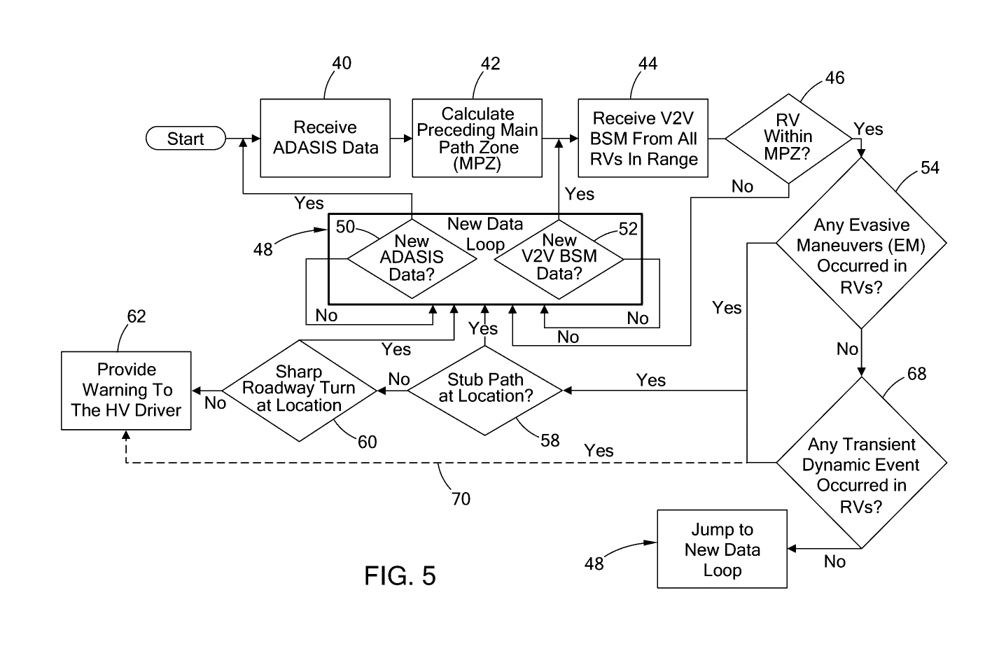

Referring to FIG. 5, a system flowchart depicts one aspect of the method performed by the road hazard identification system 20. In step 40, the ADAS module 22 provides the roadmap along with parameters for calculating the main path zone (MPZ). As previously discussed the calculation of the MPZ includes GPS coordinate, roadway curvature and stub data.

In step 42, the identification system 20 receives from the ADAS module 22 the road data and calculates the MPZ for the host vehicle 12, which incorporates at least the road geometry. In the instance of multiple lane roadways, the system can determine which lane the host vehicle 12 is in along with the remote vehicles in the vicinity transmitting BSM data. In step 44, the identification system 20 receives, via the V2V module, the BSM data from all remote vehicles within range of the wireless channel 11, which is approximately 800 m via DSRC. The BSM data includes position data (GPS coordinates) along with the various data indicated in Table 1 and/or Table 2 above. The identification system 20, in step 46, determines if the each remote vehicle 16 is within the MPZ of the host vehicle 12. If a particular remote vehicle is not within the MPZ, the system ignores and/or discards the BSM data and repeats a new data loop 48 with either new ADAS data 50 or new BSM data 52 is received by the DSRC or updated ADAS roadmap data for calculating a new MPZ of the HV 12, and repeats the above steps.

If the system determines the BSM data is from a remote vehicle within the MPZ, the system proceeds to step 54 and calculates to determine if that particular remote vehicle has performed any evasive maneuvers. The BSM data from the remote vehicle is typically transmitted approximately every 100 milliseconds. The continuously refreshed BSM data received by the identification system 20 allows for using a longitudinal acceleration and a steering angle change rate to determine if a remote vehicle within the MPZ has encountered or performed an evasive maneuver. The system is looking to determine any evasive maneuvers, e.g. sharp deceleration (or acceleration), sudden change in steering, or both, which may indicate a potential road hazard 56, such as a pothole, road debris, or other road hazard at a particular location. The identification system 20 may have a predetermined threshold for various longitudinal accelerations and/or the steering angle change rate depending on various BSM data, and the thresholds may vary based on the remote vehicle's speed of travel, size, heading and the road geometry. However, it is understood that various other changes in vehicle dynamics may be determined from the BSM data that may provide a warning to the host vehicle driver of a potential road hazard or hazardous remote vehicle (e.g. a disabled or erratic vehicle) in the MPZ for the host vehicle 12.

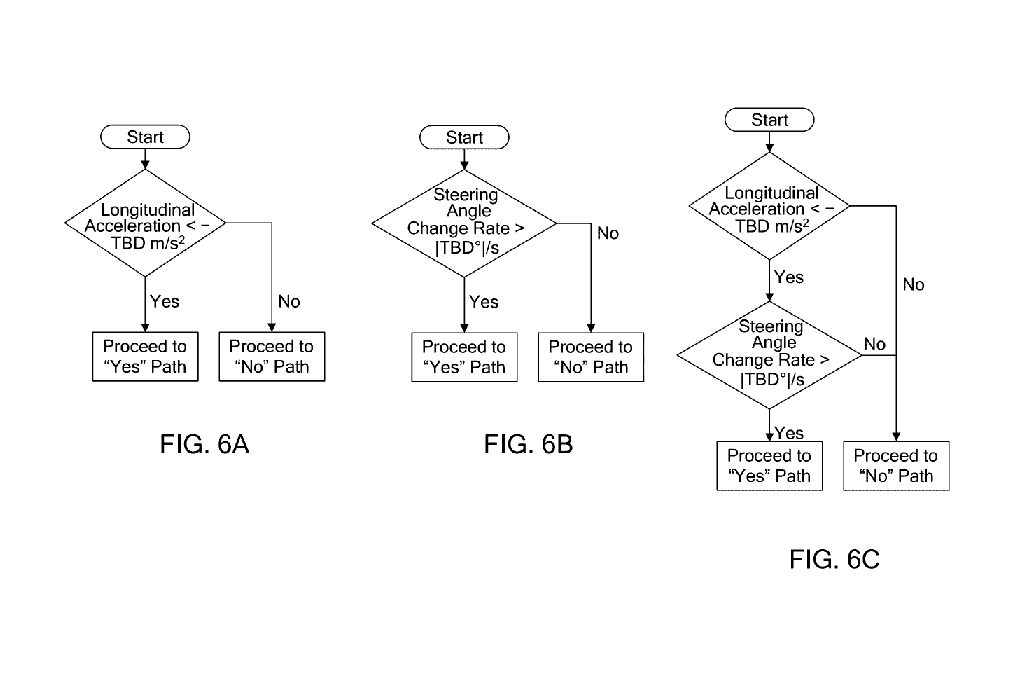

Referring to FIGS. 6A, 6B, and 6C, each figure shows an example where BSM data from the remote vehicle is compared to a predetermined threshold, or otherwise indicates an evasive maneuver has occurred. In one scenario depicted in FIG. 6A, the identification system 20 may determine if evasive maneuver occurred solely based on the longitudinal acceleration being less than or equal to a predetermined threshold. The predetermined threshold for longitudinal acceleration would be utilized for indicating a heavy braking event or stop of the remote vehicle within the MPZ. The approximate range for the predetermined threshold is indicative of multiple variables from the ADAS module such as the posted road speed, size of the remote vehicle, and/or additional BSM data from the remote vehicle such as velocity. In one scenario, the predetermined threshold for a negative acceleration may be less than approximately −1.2 m/s². However, it is appreciated that other roadmap data and BSM data may be incorporated by the system to determine the predetermine threshold for longitudinal acceleration that would be indicative the evasive maneuver to avoid the potential road hazard 56.

In another scenario depicted in FIG. 6B, the identification system 20 can determine an evasive maneuver occurred solely based on a steering angle change rate that is greater than a predetermined threshold. As with the acceleration data discussed above, the predetermined threshold may vary due to various aspects of the road geometry, size of the vehicle, yaw rate, or speed of travel of the remote vehicle transmitting the BSM data. In one example, the predetermined threshold for the steering angle change rate is greater than approximately 5° per second. It will be appreciated by those skilled in the art that other roadmap data and BSM data may be incorporated by the system to determine the predetermine threshold for the steering angle change rate of a particular remote vehicle.

In yet another scenario depicted in FIG. 6C, the identification system 20 may determine an evasive maneuver based on both longitudinal acceleration and the steering angle change rate, whereby both must exceed a predetermined value. As noted above the predetermined thresholds may vary for the reasons discussed above.

Referring back to FIG. 5, in step 58, after the identification system 20 determines the remote vehicle transmitting the BSM had an evasive maneuver, the system will then look to the ADAS roadmap data and determine if the evasive maneuver took place at a stub path location 33 (FIGS. 2 and 3). If the identification system 20 determines yes, the maneuver is assumed to be due to the remote vehicle turning or changing paths at a stub, e.g. at an intersection, the system 20 will determine the event is not an evasive maneuver indicating a potential road hazard. In this event the system will proceed to the new data loop 48 and repeat the above-noted steps. However, if the system determines that the remote vehicle is not at a stub path location 33, the system proceeds to step 60. Similar to step 58, he system 20 here determines whether the evasive maneuver corresponds to a sharp turn (as indicated by the road map data) or a path having road geometry that would account for such acceleration and steering angle changes in the remote vehicle. If yes, the system 20 will return to a new data loop 48 and repeat the steps above. If no, the system will proceed to step 62 and indicate a warning to the driver of the host vehicle.

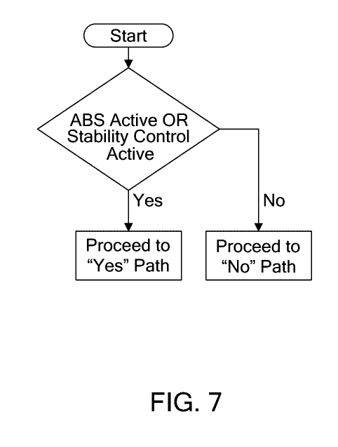

As noted above, the identification system 20 can also utilize BSM data to identify other dynamic events in a remote vehicle 16. In step 68, the system 20 determines if the remote vehicle transmitting the BSM had any transient dynamic events. Dynamic events in the remote vehicle may relate to the braking system data, anti-lock braking status and stability control system status. With reference to FIG. 7, the determination of a dynamic event preferably includes identifying whether the anti-lock braking system or stability control system are active in a remote vehicle within the MPZ. If such systems are active, the identification system 20 may continue down the yes path to steps 58 and 60, to evaluate if there was a stub path location and/or the road geometry that may have cause the remote vehicle to activate the dynamic event. However, the system 20 may optionally, as indicated by the dashed line 70 in FIG. 6, proceed directly to indicating a warning to the host vehicle driver. In particular, the anti-lock braking system and stability control system status is typically indicative of a hazardous road condition regardless of the presence of a stub or sharp curve in the roadway, where a driver may lose control of the vehicle. The anti-lock braking and stability control systems are commonly activated and provide indication of roadways within the MPZ with compromised coefficients of friction. Additionally, the system 20 may look for other dynamic events within the BSM data of the remote vehicle, such as accident avoidance systems, airbag inflation or other system that would indicate the remote vehicle has been in an accident, or is disabled within the MPZ of the host vehicle.

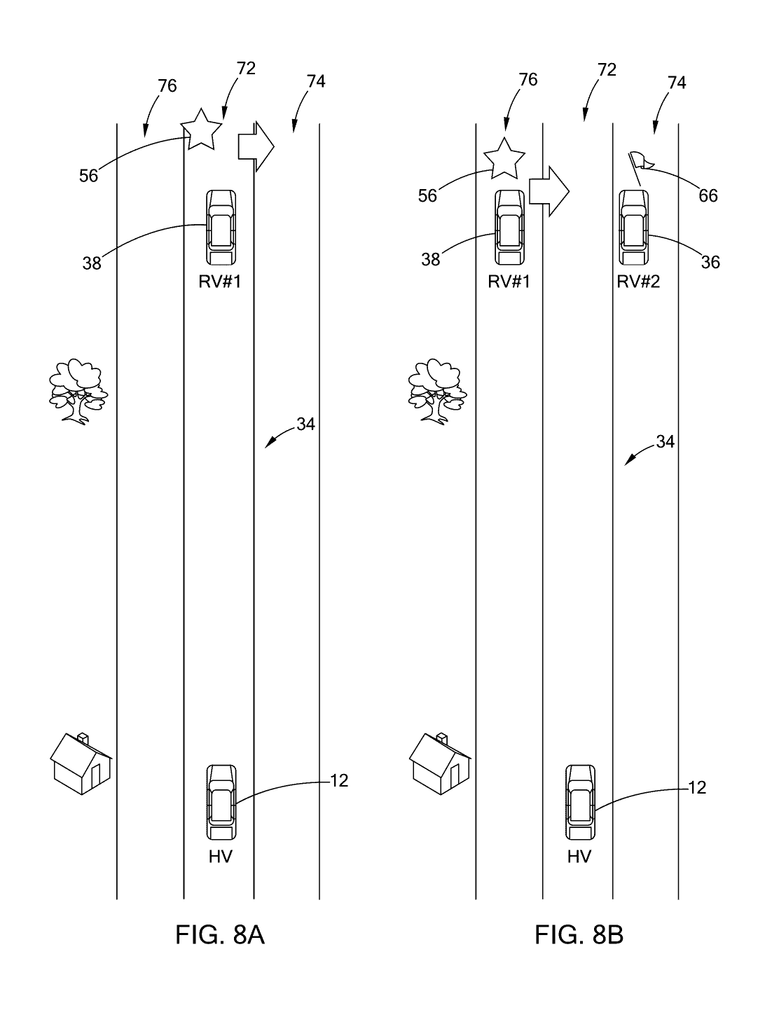

Referring now to FIG. 8A, the first remote vehicle 38 is ahead of the host vehicle 12 in a center lane 72, and in this example, the same lane of travel and within the MPZ 34 of the host vehicle 12. The remote vehicle 38 has swerved out of the center lane 72 toward a right adjacent lane 74. In this example, if the system 20 determines the maneuver exceeds the predetermined threshold for acceleration or steering angle change rate, and the identification system 20 will indicate to the driver of the host vehicle 12 a potential road hazard 56, e.g. ahead on the left side of the MPZ 34. The remote vehicle's change of direction, relative to the host vehicle 12, and distance to the potential road hazard 56 may also be indicated to the driver. Optionally, the identification system 20 may also send the determination of the potential road hazard 56 to a stability control system (not shown) of the host vehicle 12. Since the stability control systems may control various systems in the host vehicle 12 such as steering, braking, and engine throttle. In some cases, the host vehicle 12 may include stability control systems that include various lane detection and lane maintenance controls for assisting the driver by automatically veering the host vehicle 12 to avoid the identified potential road hazard 56.

Referring to FIG. 8B, the system 20 may further determine a projected path of the remote vehicle 38, as indicated by a right arrow 64. The system 20 may signal or indicate a warning to the driver of the host vehicle 12, if the projected path of the remote vehicle enters into or within the MPZ 34, as previously determined. In this example, the potential road hazard 56 is in a left adjacent lane 76 and not within the indicated MPZ 34, but since the first remote vehicle 38 has the predicted projected path of entering into the MPZ 34, the system 20 may indicate to the driver of the concern for vehicles swerving into the MPZ, i.e. the remote vehicle 38 itself being a potential road hazard within the MPZ. The system 20 may indicate such events as a warning to the driver of the host vehicle 12 that traffic may swerve into from the left lane 76 into the center lane 72 of travel to avoid the potential road hazard 56. In addition, the system 20 may indicate for the driver to maintain in the center lane 72 and/or indicate the potential hazard 56 in the adjacent left lane 76. Also, the system 20 in this scenario may discard BSM data 66 from the second remote vehicle 36 since the BSM data 66 does not indicate the projected path into the MPZ. However, it is possible for the system 20 to indicate the potential hazard 56 or suggest to the driver recommended lanes along a roadway based on the BSM data from the remote vehicles on the same road, but in a different lane that may be outside the MPZ 34.

While the MPZ in FIGS. 8A and 8B has been indicated as only the center lane 72 (which is the lane of travel of the host vehicle 12), it will also be appreciated by the skilled artisan that the MPZ can include adjacent lanes of travel, including both adjacent lanes travelling in the same direction or lanes in the opposite direction. For example, on a two-lane road, a remote vehicle travelling in the opposite direction of the host vehicle may swerve into the lane of the host vehicle, suggesting that other remote vehicles may make the same maneuver. Likewise, if there is a sudden change in steering angle change rate as the remote vehicle returns to its proper lane, the system will identify a potential road hazard even when the MPZ only includes the lane of travel. The skilled artisan will recognize the MPZ can be adjusted based on the type of road on which the host vehicle is travelling (determined based on ADAS data), and can include multiple lanes of vehicle travel. Preferably, the MPZ includes only the immediate lane of travel as this presents the most immediate risk of a road hazard affecting the host vehicle.

Additional benefits may be seen by the host vehicle 12 transmitting the evasive maneuvers, dynamic events, and/or potential road hazards via the V2V module 14 and wireless channel 11 to cascade such information to other vehicles in the vicinity. Further benefits may include transmitting fixed road hazards, such as road debris or pot holes, to roadway authorities to identify paths or roads in need of attention or maintenance. The host vehicle 12 may further provide and upload the BSM and determination of the evasive errors and dynamic events through the data connection allowing a flag for vehicles not in the vicinity at the time of the event and also allow roadway authorities to tabulate events that may signify a potential road hazard.

What is claimed is:

1. A method for identifying a potential road hazard in a host vehicle based on a remote vehicle, the host vehicle having a host vehicle-to-vehicle (V2V) module and an host advanced driver assistance system (ADAS) module, the remote vehicle having a remote V2V module providing a position of the remote vehicle and one or more of longitudinal acceleration, steering angle change rate, braking system status, anti-lock braking system status, and stability control system status of the remote vehicle, the method comprising the steps of:
(a) computing a main path zone (MPZ) of the host vehicle using the host ADAS module;
(b) receiving the position of the remote vehicle using the host V2V module;
(c) determining if the remote vehicle is in the MPZ of the host vehicle;
(d) receiving a signal having at least one of longitudinal acceleration, steering angle, anti-lock braking system status, and stability control system status of the remote vehicle using the host V2V module;
(e) determining a potential road hazard when the signal indicates any of the following are true, the longitudinal acceleration exceeds a predetermined threshold, the steering angle change rate exceeds a predetermined threshold, the anti-lock braking system status is active, or the stability control system status is active; and
(f) indicating the potential road hazard to a driver of the host vehicle when the remote vehicle is in the MPZ of the host vehicle.

2. The method of claim 1, wherein the step of determining a potential road hazard includes the signal indicating that both the steering angle change rate and the longitudinal acceleration exceed their respective predetermined thresholds.

3. The method of claim 1, wherein the step of computing the MPZ includes identification of road geometry in the area of the host vehicle, heading of the host vehicle, and immediate and adjacent lanes of travel for the host vehicle.

4. The method of claim 1, wherein the MPZ is computed to only include the immediate lane of travel for the host vehicle.

5. The method of claim 1, wherein the step of determining if the remote vehicle is in the MPZ occurs before the step of determining a potential road hazard such the step of determining a potential road hazard is only performed on a remote vehicle in the MPZ of the host vehicle.

6. The method of claim 1, further comprising the step of determining a projected path for the remote vehicle and indicating a warning to the driver if the projected path is within the MPZ.

7. The method of claim 6, wherein the remote V2V module further provides, and the host V2V module receives, one or more of heading of the remote vehicle, speed of the remote vehicle, steering angle of the remote vehicle, and acceleration of the remote vehicle, and wherein the projected path is determined based on the position and one or more of heading, speed, steering angle and acceleration of the remote vehicle.

8. The method of claim 1, wherein the predetermined threshold for longitudinal acceleration is less than or equal to negative 1.2 m/s².

9. The method of claim 1, wherein the predetermined threshold for the steering angle change rate is greater than 5 degrees/second.

10. The method of claim 1 further comprising, before the step of indicating the potential road hazard, the step of determining if the MPZ includes a stub adjacent the position of the remote vehicle and repeating steps (a) through (e) if there is a stub adjacent the position of the remote vehicle.

11. The method of claim 1, further comprising, before the step of indicating the potential road hazard, the step of determining if the MPZ includes a sharp turn adjacent the position of the remote vehicle, and ,repeating steps (a) through (e) if there is a sharp turn at the position of the remote vehicle.

12. The method of claim 1, wherein, when the potential road hazard is determined based on the steering angle change rate, the step of indicating includes indicating a direction of the steering angle change.

13. The method of claim 12, wherein the step of computing the MPZ includes identification of immediate and adjacent lanes of travel for the host vehicle, and wherein, when the remote vehicle is determined to be in an adjacent lane and the direction of the steering angle change may move the remote vehicle into the immediate lane, a potential road hazard is determined.

14. The method of claim 1, further comprising the step of sending the determination of the potential road hazard to a stability control system of the host vehicle.

15. The method of claim 14, wherein the stability control system includes one or more of steering control and braking control to shift the host vehicle within the MPZ to avoid the potential road hazard.

16. The method of claim 1, further comprising the step of transmitting the determination of the potential road hazard to a network using the V2V module of the host vehicle.

17. A road hazard identification system for a host vehicle having a host vehicle-to-vehicle (V2V) module and an host advanced driver assistance system (ADAS) module, the host ADAS module computing a main path zone (MPZ) of the host vehicle, the host vehicle communicating with a remote vehicle having a remote V2V module, the host V2V module receiving position data and at least one of longitudinal acceleration, steering angle change rate , braking system status, anti-lock braking system status, and stability control system status of the remote vehicle from the remote V2V module, the road hazard identification system comprising:
a processor configured to (a) determine if the remote vehicle is in the MPZ of the host vehicle, (b) determine a potential road hazard when either the longitudinal acceleration exceeds a predetermined threshold, the steering angle change rate exceeds a predetermined threshold, the anti-lock braking system status is active, or the stability control system status is active, and (c) send a signal indicating the potential road hazard to a driver of the host vehicle when the remote vehicle is in the MPZ of the host vehicle.

18. The road hazard identification system of claim 17, wherein the processor determines a potential road hazard when both the steering angle change rate and the longitudinal acceleration exceed their respective predetermined thresholds.

19. The road hazard identification system of claim 17, wherein the processor determines if the MPZ includes a stub or a sharp turn adjacent the position of the remote vehicle, and wherein the processor does not send the signal indicating the potential road hazard when the position of the remote vehicle is adjacent the stub or the sharp turn.

20. The road hazard identification system of claim 17, wherein the processor is configured to send a signal indicating the determination of the potential road hazard to a stability control system of the host vehicle.
